(19) United States
(12) Patent Application Publication
(10) Pub. No.: US 2017/0050055 A1
(43) Pub. Date: Feb. 23, 2017

(54) Auto-Blocking Rappelling and Belaying Device

(71) Applicant: Patrick Michael Spydell, JR., Reno, NV (US)

(72) Inventor: Patrick Michael Spydell, JR., Reno, NV (US)

(21) Appl. No.: 15/243,976

(22) Filed: Aug. 23, 2016

Related U.S. Application Data
(60) Provisional application No. 62/208,761, filed on Aug. 23, 2015.

(51) Int. Cl. A62B 1/14; A63B 29/02

(52) U.S. Cl. CPC A62B 1/14; A63B 29/02

(57) ABSTRACT

One embodiment of the present invention relates to an auto-blocking rappelling and belaying device with a main housing, a pivotally mounted flap and a cam pivotally coupled to the main housing via an axle. The cam has a first groove and a second groove that are located parallel to one another. In operation one or two stands of rope may be located in the first and second groove and the device enables a user to selectively feed a rope or ropes which are located in one or both of the grooves through the device as in a rappelling or belaying scenario.

### BACKGROUND OF THE INVENTION

Rock climbing is a common recreational activity. There are many different types of rock climbing including bouldering, traditional climbing and aid climbing. Typically traditional and aid climbing involve climbing rock faces that are up to a mile in high. In such situations, participants commonly use ropes to prevent a slip from resulting in a fall to the participant's death.

The use of ropes to protect a climber against a fall is known as belaying. Belaying is accomplished by running a rope from a first climber through one or more fixed or removable anchor points and then tying the rope to a second climber. If the second climber falls the first climber restrains the rope and the second climber's fall is arrested when the rope comes tight against the highest of the one or more anchor points.

In order to arrest the fall of the second climber, the first climber uses what is known as a belay device. Belay devices take many forms, but are primarily broken into two types; auto-blocking and conventional belay devices. Conventional belay devices use friction to enable the first climber to use only a light force to restrain the movement of the rope during a loading situation such as a fall of the second climber. Auto-blocking belay devices use a cam type device or leverage arm to automatically stop a rope from feeding through the device during a loading event such as a fall by the second climber. With auto-blocking belay devices, the cam type device or leverage arm remains disengaged during light loading which allows a user to feed rope through the device. However above a certain threshold the device prevents any movement of the rope through the device.

In addition to belaying a second climber, belay devices are used for rappelling. During a rappel, a climber uses the belay device to provide a controlled decent down a rope that is anchored above the climber. During a rappel a climber may be descending one strand of rope or two. Conventional devices are capable of allowing a climber to descend one or two strands of rope. However, existing auto-blocking belay devices are only designed to accommodate one strand of rope.

There exists a need in the art for an auto-blocking belay device that is designed to accommodate two strands of rope. Such a device would enable a climber to have a single device that is suitable for use both single and double strand belaying and single and double strand rappels.

### SUMMARY OF THE INVENTION

Aspects of the current invention are directed toward an auto-blocking device which is suitable for use with up to two rope strands. In the preferred embodiment, the auto-blocking device has a cam with two grooves located adjacent to one another, a main housing, a flap and a handle. During loading of the auto-blocking device a rope strand is placed into one of the grooves in the cam. The dual groove configuration enables a user to use the auto-blocking device to selectively control the movement of the one or two ropes through the auto-blocking device.

### BRIEF DESCRIPTION OF THE DRAWING

FIG. 1 shows a perspective view of one embodiment of the invention with a carabiner shown for reference;

FIG. 2 shows a perspective view of one embodiment of the invention;

FIG. 3 shows a perspective view of one embodiment of the invention;

FIG. 4 shows a perspective view of one embodiment of the invention with the flap in the open position;

FIG. 5 shows a perspective view of one embodiment of the invention with the flap in the open position and two strands of rope shown for reference;

FIG. 6 shows a side view of one embodiment of the invention with the flap in the open position and the cam in the open position;

FIG. 7 shows the side view of FIG. 6 with the flap not shown for clarity and the cam in the closed position;

FIG. 8 shows an exploded view of one embodiment of the invention;

FIG. 9 shows a perspective view of one embodiment of the invention with the handle in the lowering position;

FIG. 10 shows a perspective view of the cam;

FIG. 11 shows a side view of the cam and a torsion spring;

FIG. 12 shows a bottom view of the cam with two strands of rope shown for reference;

FIG. 13 shows a perspective view of an embodiment of a cam with the pinch surface visible;

FIG. 14 shows a perspective view of an embodiment of a cam with the pinch surface visible.

### DETAILED DESCRIPTION OF THE INVENTION

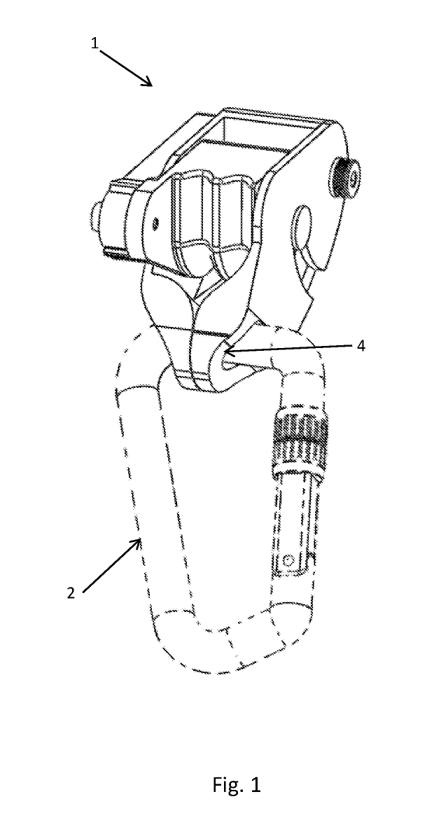

Referring to FIG. 1, FIG. 1 shows a perspective view of an auto-blocking device 1 constructed according to aspects of the invention. Shown in broken lines is a carabineer 2. The carabineer 2 is shown to help depict how the auto-blocking device 1 is used in practice. In practice, the carabineer 2 is attached to the clip-in hole 4 and then used to secure the auto-blocking device 1 to a harness worn by a climber or rescue personal, typically by attachment to a belay loop or harness tie-in point.

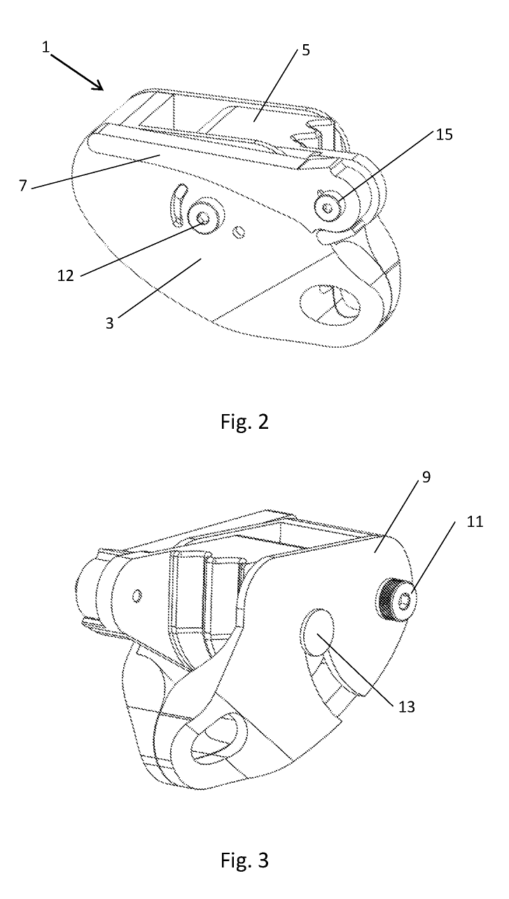

FIG. 2 and FIG. 3 show perspective views of an auto-blocking device 1 constructed according to aspects of the invention. Shown in FIG. 2 is the cam 5, main housing 3, axle mounting bolt 12, handle 7 and the handle axle bolt 15. FIG. 3 shows the auto-blocking device 1 from an opposite perspective of FIG. 2. Shown in FIG. 3 is the flap pivot bolt 11, the flap 9 and the axle 13.

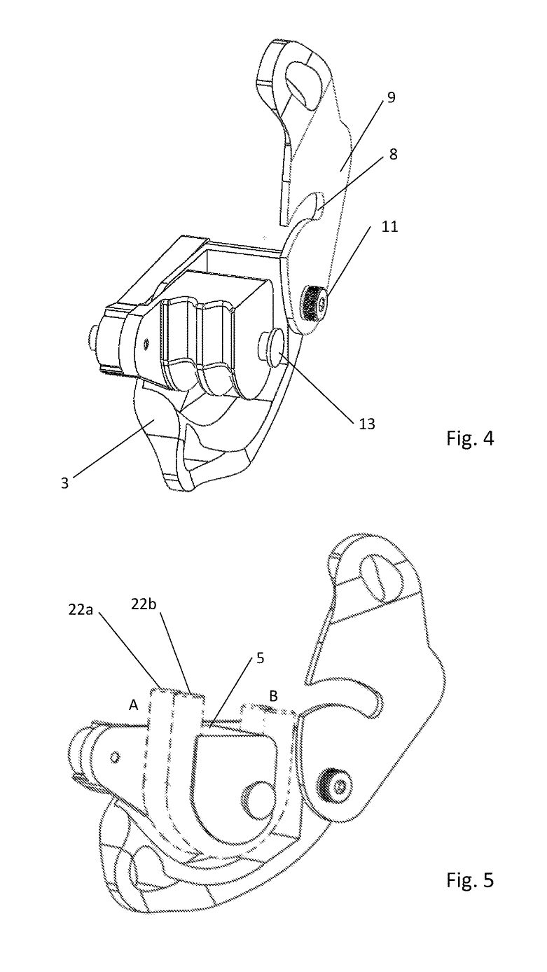

Referring to FIG. 4, FIG. 4 shows the flap 9 in the open position. The flap 9 is pivotally mounted on the flap pivot bolt 11. The flap 9 is in some embodiments capable of full 360 degree rotation about the flap pivot bolt 11. However, for future discussion the term “open position” is used to refer to the position of the flap 9 relative to the main housing 3 as depicted in FIG. 4. The term “closed position” is used to refer to the position of the flap 9 relative to the main housing 3 as depicted in FIG. 3. In FIG. 4 a shoulder on the axle 13 is visible. When the flap 9 is in the closed position the shoulder on the axle 13 rests against the axle bearing surface 8 on the flap 9. In some embodiments the axle 13 is a part of the main housing 3 rather than a separate component.

In FIG. 5 a first and second strand of rope 22a, 22b are shown in broken lines. The two strands of rope 22a, 22b are wrapped about the cam 5 as they would be during loading of rope into the auto-blocking device 1. Also identified are side A and side B. A and B are used to reference particular sides of the ropes 22a, 22b relative to the cam 5. However, the use of two strands of rope 22a, 22b is not necessary, because the auto-blocking device 1 is also suitable for use with a single strand of rope. When using a single strand of rope, the single strand of rope may be located in either of the grooves 19a, 19b.

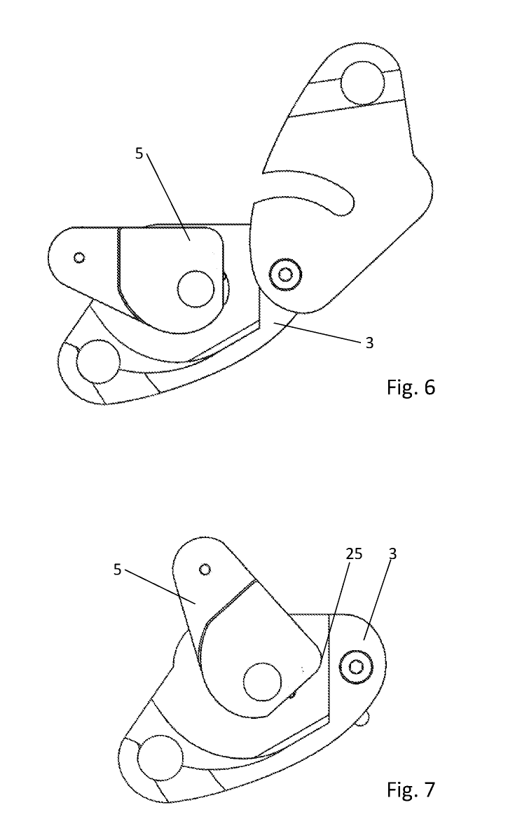

Referring to FIG. 6 and FIG. 7, these figures depict side views of the auto-blocking device 1 and are useful for depicting the movement of the cam 5 during operation of the device. In use the auto-blocking device 1 is loaded with one or two strands of rope as shown in FIG. 5. Then the flap 9 will be moved to the closed position, thus preventing the movement of the rope strand (s) from a location in the grooves 19a, 19b on the cam 5 and between the main housing 3 and the flap 9. The flap 9 is shown in the open position in FIG. 6 in order to provide a clear view of the cam 5. The flap is omitted in FIG. 7 in order to permit a clear view of the movement of the cam 5. This is because in practice, the flap 9 will be in the closed position during the operation of the device in a belaying or rappelling type scenario.

During operation, a user may feed one or two rope strands through the auto-blocking device 1 from area A to area B, or from area B to area A. When feeding the one or two rope strands through the auto-blocking device 1, the user will experience only the limited resistance created by the friction between the one or two rope strands and the cam 5 as the one or two rope strands route around the cam 5. Under such conditions, the cam 5 remains substantially in the open position shown in FIG. 6 the torsion spring 28 helps to provide a bias to keeping the cam 5 in the open position. However in a situation where a large load is placed on side A of the one or two ropes (such as a climber falling, or a climber rappelling) the cam 5 rotates to a position such as the one shown in FIG. 7. The exact degree of rotation will vary depending upon the diameter of the rope being used in the auto-blocking device 1. When the cam 5 rotates to this position, the pinch surface 25 on the cam 5 moves toward the main housing 3. When this movement takes place, the cam 5 pinches the one or two ropes against the main housing 3. As a result the auto-blocking device 1 prevents the translation of the one or two ropes about the cam 5 from area B to area A.

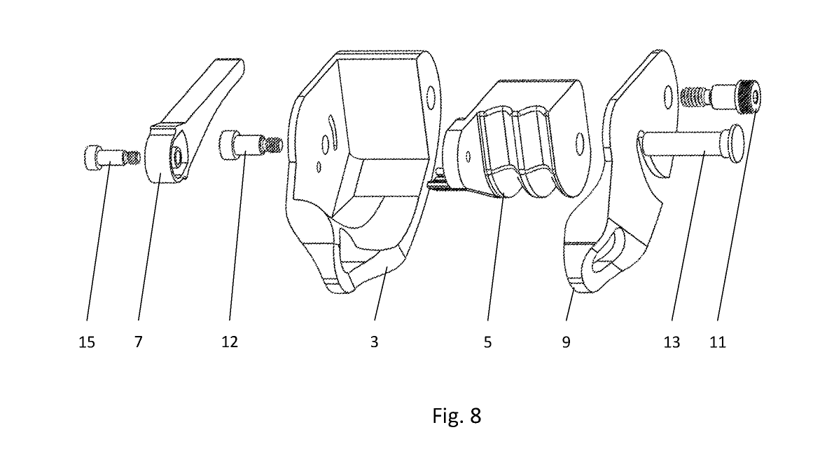

FIG. 8 shows an exploded view of the auto-blocking device 1 as depicted in FIG. 3. Shown in FIG. 8 is the handle axle bolt 15, handle 7, axle mounting bolt 12, main housing 3, cam 5, flap 9, axle 13 and flap pivot bolt 11. In this embodiment, the axle mounting bolt 12 is a shoulder bolt that threads into the axle 13. This configuration enables any load placed on the cam to be carried via a shoulder on the axle mounting bolt 12 to the main housing 3. Also suitable is to have the axle 13 be a rivet type design where the axle 13 is secured through the cam 5 and into the main housing 3 by a riveting type operation. Additionally, the axle 13 may be machined out of a contiguous piece of material with the main housing 3.

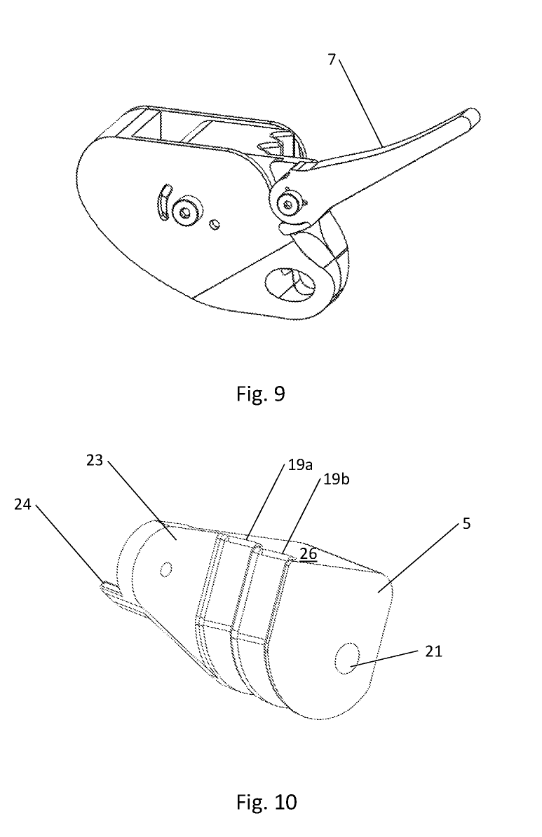

FIG. 9 depicts the handle 7 in the lowering position. During standard operation of the auto-blocking device 1 the handle 7 remains in the position shown in FIG. 2. However when the cam 5 rotates to pinch one or two ropes, the cam 5 locks the one or two ropes in place and a user is unable to feed rope from side B to A (feeding out rope) or from side A to B (taking in rope). In order to permit a user to feed rope through the auto blocking device 1 after the cam 5 has engaged the one or two ropes, a user may rotate the handle 7 to the lowering position. By applying a downward force on the handle 7 when the handle is in the lowering position the user forces the cam 5 to rotate such that the effective pressure of the pinch surface 25 on the one or two ropes is reduced. With sufficient rotation of the cam 5, via the handle 7, the one or two ropes will start to slide through around the cam 5 from side B to side A (loading will always occur from side A). In practice, this means the user will be able to controllably lower a climber, or modify her or his repelling speed by selective application of downward force on the handle 7 when the handle 7 is in the lowering position.

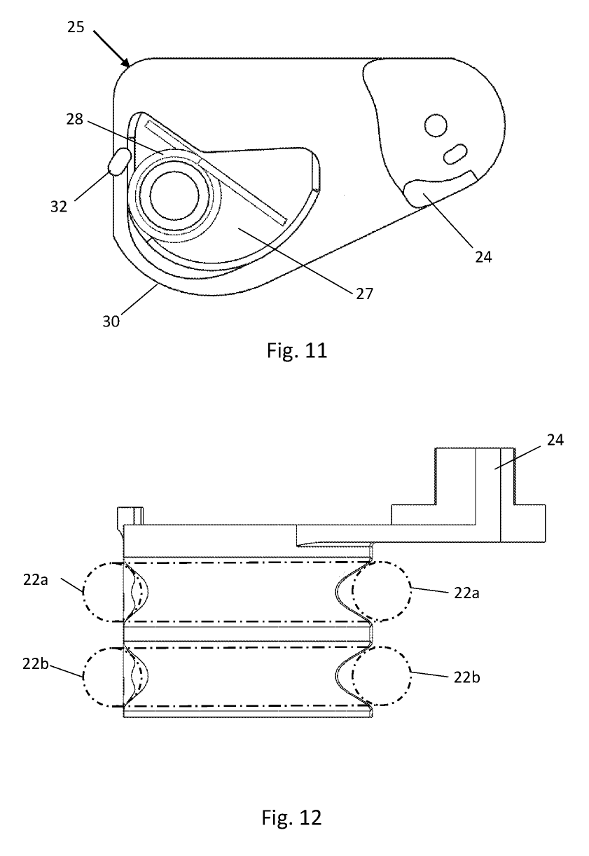

FIG. 10 depicts the cam 5 in isolation from the remainder of the auto-blocking device 1. The cam has a handle mounting arm 23, a handle rotation stop 24, a first groove 19a and second groove 19b, and axle mounting hole 21. The top surface of the cam 5 is identified by reference number 26. FIG. 11 shows the cam 5 in a side view taken from a side not visible in FIG. 10. In FIG. 11, a torsion spring 28 is visible in the spring pocket 27. Also identified is the pinch surface 25. FIG. 12 shows a bottom view of the cam 5 with a first and a second rope 22a, 22b shown in broken lines running under the cam 5. In operation, the one or two ropes run under the cam 5, relative to the top surface 26 of the cam. In FIG. 12 the first and second ropes 22a, 22b are depicted located in the first groove 19a and second groove 19b respectively. Referring to the first and second groove 19a, 19b in more detail, in the preferred embodiment they have a cross sectional shape that is suitable for receiving a rope with a diameter between 8 mm and 12 mm. The shape is suitable when it is sized to help locate the strand of rope in a particular groove and to provide enough contact between the rope and the cam 5 surface to enable the user to be able to control the movement of the rope in a loaded condition. In different embodiments, the range of suitable rope diameters may be less, for example 9 mm to 11 mm or greater. The cross section profile of the grooves 19a, 19b may be a simple circular arc, however, in the preferred embodiment, the profile is a “v” type shape. The benefit of the “v” type cross sectional profile is that the “v” type profile will tend to provide desirable friction on a wide range of different rope diameters. Additionally, this profile assists with creating friction against the cam 5 which ensures that even on icy or wet ropes, there is sufficient friction on the cam 5 to activate the cam 5 and rotate it to actuate the auto-blocking feature of the auto-blocking device 1.

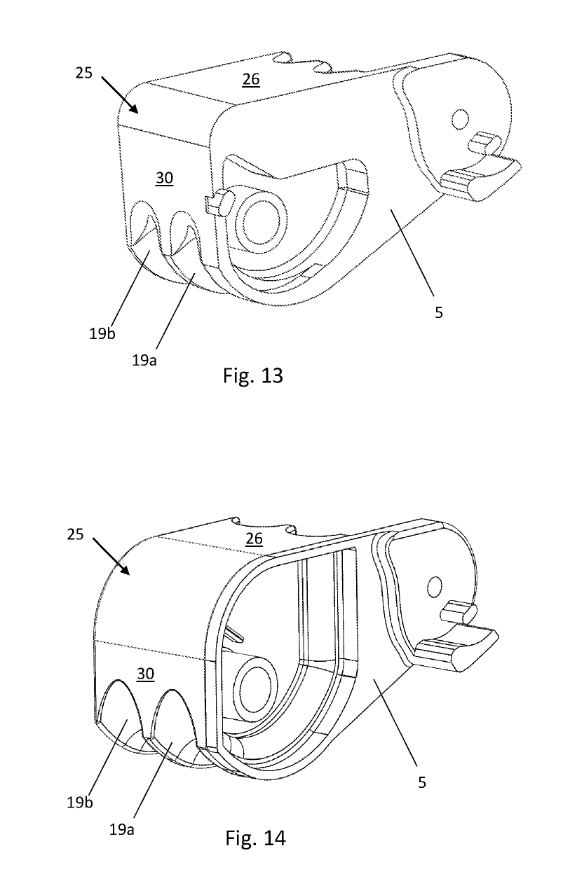

Referring to FIG. 13 and FIG. 14, these figures show a cam 5 constructed according to aspects of the invention. FIG. 13 is a view of the cam 5 as depicted in FIG. 10-12 with a clear view of the pinch surface 25. FIG. 14 is an embodiment of a cam 5 wherein the pinch surface 25 has a larger radius than in the embodiment shown in FIG. 13. Depending upon the particular rope diameter for which the auto-blocking device 1 is designed to function with, a different radius or shape of the pinch surface 25 may be preferred. In FIG. 13 the pinch surface 25 has a 0.25″ radius while in FIG. 14 the pinch surface has 0.6″ radius. As a result of differing radii and/or shapes of the pinch surface 25 the grooves 19a, 19b may terminate closer or further from the pinch surface 25. The grooves 19a 19b start at area A where they transect the top surface 26 and extend circumferentially about the cam 5 to near the pinch surface 25. In some embodiments, the grooves 19a, 19b may terminate at the edge of the pinch surface 25. In other embodiments, the grooves 19a, 19b may blend into an orthogonal surface 30 that is orthogonal to the top surface 26 and this orthogonal surface 30 may then extend to the pinch surface 25, as shown in FIG. 13 and FIG. 14.

Referring back to FIG. 11, the shape of the cam 5 results in the auto-blocking feature of the auto-blocking device 1. The cam is mounted on an axle 13 that runs through the axle mounting hole 21. The cam 5 can pivot about the axle 12 subject to the torsion spring 28 acting against a stop in the main housing 3 which provides a bias toward maintaining the cam in the open position, and the cam stop 32 engaging against the main housing 3. The cam 5 has a curved surface 30 at its bottom extent. In the preferred embodiment this curved surface 30 has a substantially logarithmic curve and this curve is matched in the first and second groove 19a, 19b as they extend circumferentially about the cam 5. As a result of the curved surface 30 creating friction, when a strand of rope is pulled at area A, the cam will tend to rotate and pinch that strand of rope between the pinch surface 25 and the main housing 3 near area B. The curve of the first and second grooves 19a, 19b need not necessarily be logarithmic, a circular or elliptical curve is also suitable.

Referring to the main housing 3 and flap 9 in more detail, they may be constructed out of any material that is suitable for withstanding the loads created in a particular embodiment of the invention. For a climbing adapted embodiment an anodized aluminum material is suitable. Also suitable would be a carbon fiber type material, a steel material, or a titanium material. Referring to the cam 5 in more detail, the cam 5 may be constructed of a material that can withstand the abrasion of a rope against the first and second groove 19a, 19b and the pitch surface 25 and sustain a load on the axle mounting hole 1 suitable for the particular embodiment. In a climbing adapted embodiment, a stainless steel type material is preferred. Also suitable are steel, aluminum and titanium materials.

Further, an alternative non-illustrated embodiment of an auto-blocking device constructed in accordance with the present invention comprises a main housing, a flap and an axle as discussed above. However, the alternative embodiment comprises a first cam and a second cam rather than a single cam. In such an embodiment the first cam has groove for receiving a single rope and the second cam has a groove for receiving a second single rope. The cross-section of the groove in the first cam and the groove in the second cam are constructed according to the foregoing discussion on the cross section of the groove in a cam with two grooves. Additionally, the grooves in the first and second cam may be the same size, but may also be differently sized to accommodate different size ropes.

In the alternative embodiment the first and second cam are located adjacent to one another. The first cam may independently rotate about the axle in a direction that moves the pinch surface toward the main housing. The second cam is configured such that when the second cam is forced to rotate about the axle toward the main housing by a rope running in the second cam groove (such as during a rappel or a climber falling) the first cam is also forced to rotate about the axle toward the main housing. The independent rotation of the cams permits the control of a single rope strand at a time rather that both strands at once. The first and second cam may be rotated about the axle with a handle which is coupled to the first cam. As a result of the first cam and second cam being coupled as described, the handle which is operable for rotating the first cam about the axle is also operable for rotating the second cam about the axle when the second cam causes the first cam to rotate. Such a configuration permits the embodiment of an auto-blocking device to control the first cam and second cam with a single handle.

While the foregoing written description of the invention enables one of ordinary skill to make and use what is considered presently to be the best mode thereof, those of ordinary skill will understand and appreciate the existence of variations, combinations, and equivalents of the specific embodiments and examples herein. The invention should therefore not be limited by the above described embodiments and examples, but by all embodiments within the scope and spirit of the invention as claimed.

What is claimed is:

1. An auto-blocking belay device comprising:
a main housing and a flap wherein said flap is pivotally mounted to said main housing;
a cam pivotally coupled to said main housing with an axle wherein said cam has a first groove and a second groove wherein said first groove and said second groove are located parallel and adjacent to one another and extend circumferentially around said cam;
a handle wherein said handle is pivotally mounted to said cam and wherein said handle is operable for rotating said cam about said axle.

2. The device of claim 1 wherein said cam comprises a pinch surface, an orthogonal surface, and a top surface and said circumferential extension of said first groove and said second groove extends from said top surface to said orthogonal surface wherein said orthogonal surface is located orthogonally to said top surface and extends between the extent of said first groove and said second groove to said pinch surface.

3. The device of claim 1 wherein said cam comprises a pinch surface and a top surface and said circumferential extension of said first groove and said second groove extends from said top surface to said pinch surface.
